(19) United States
(12) Patent Application Publication
(10) Pub. No.: US 2011/0118908 A1
(43) Pub. Date: May 19, 2011

(54) METHODS AND SYSTEMS FOR MANAGEMENT OF AIRPLANE SPEED PROFILE

(75) Inventors: Daniel J. BOORMAN, Woodinville, WA (US); Peter D. GUNN, Redmond, WA (US); Randall J. MUMAW, Seattle, WA (US)

(73) Assignee: THE BOEING COMPANY, Seal Beach, CA (US)

(21) Appl. No.: 12/621,298

(22) Filed: Nov. 18, 2009

(51) Int. Cl. G05D 1/00; G06F 17/00

(52) U.S. Cl. 701/14

(57) ABSTRACT

Methods and systems for airplane speed profile management are disclosed. A method and system in accordance to one embodiment of the disclosure includes a graphical display of speed segments and constraints as well as controls for managing the speeds and associated constraints. Speed Profile Management System (SPMS) provides an integrated and interactive speed profile management tool where pilots can view, update, or change the speed profile of their airplane's current or subsequent phases of flight.

### TECHNICAL FIELD

Aspects of the present disclosure are directed to the management of airplane speed profile and associated systems and methods.

### BACKGROUND

Modern commercial aircraft are equipped with several airplane systems to manage their flight profile and configuration. For example, one of the several functions of the Flight Management Computers (FMC) entails the planning and management of navigation profile of an airplane from takeoff to landing. The Mode Control panel (MCP) provides means for pilots to manage certain aspects such as the lateral and vertical flight profiles of an airplane. Both the FMC and MCP may be used to control the autopilot and autothrottle systems that may in turn send commands to other airplane systems such as the engines and flight control systems to direct and control the airplane consistent with the pilots' commands. Feedback as to the performance of the airplane in relation to the pilots' commands may be available in a number of locations in the cockpit (flight deck) including the Primary Flight Displays (PFD), Navigation Displays (ND), Mode Control Panels (MCP), Control Display Units (CDU), and Crew Alerting Displays.

As airplanes and the airspace environment in which they operate have evolved to become more complex, airplane systems available to pilots, as well as, the flight profiles pilots manage have gotten more complex. One aspect of a flight profile whose management poses a challenge is speed. The speed profile of modern commercial aircraft is influenced by myriad input. For example, such input may include the aircraft's speed capability and optimum economic performance given certain input constraints such as its configuration, available weather data, and desired time of arrival. It also may be influenced by altitude-based restrictions such as speed at-or-less than 250 knots below 10,000 feet. Furthermore, an aircraft's speed may also be constrained by speed restrictions or constraints attached to waypoints that define its route. In addition, performance requirements related to new Air Traffic Management (ATM) functions such as Continuous Descent Approaches (CDA) may also have to be factored in to obtain a more comprehensive assessment of the speed profile for an airplane.

The combination of these various types of influences on the airplane's speed, which are managed with safety and fuel economy objectives as well, can result in a complicated speed schedule that can be difficult to comprehend utilizing the aforementioned multiple systems currently engaged in speed profile management. The sequence of speed restrictions, including overlapping ones that may override one another, make it harder for pilots to anticipate speed changes, understand the reasons for them when they occur, and ultimately manage them consistent with applicable requirements for the route, airspace rules, airline-specific policy, and the airplane's performance.

The need to monitor and utilize these different systems contributes to increased workload, and potentially to errors or anomalies. The errors and anomalies may result in impact to economic performance, reduction in situational awareness, inability to stay on an approved flight path, and potentially cause disruption to air traffic flow on the airplane's route or the airspace through which the airplane is flying. Thus, there is a need for a tool that simplifies the flight crew's awareness and management of the airplane speed profile in all phases of flight.

### SUMMARY

One way of meeting this need is by a speed profile management tool that enables pilots to plan, input, modify, and understand their aircraft's current and projected speed profile, in a simple and efficient manner for all phases of flight.

The present disclosure addresses this need via a Speed Profile Management System (SPMS) and interactive formats to support it. The SPMS integrates and transforms previously scattered speed-related information into an integrated graphical depiction of speed displayed in a cockpit graphical display system. The SPMS is able to display all speed-related information in a single location of choice in the cockpit, including a suitable forward-view location for the pilot and copilot.

Thus, in lieu of monitoring and interpreting different information provided on the PFDs, CDUs, and MCPs, pilots can look to one system—the SPMS—and understand the speed profile of their aircraft, thereby quickly recognizing errors that may affect the airplane's ability to stay on the desired path. In addition, the SPMS enables pilots to easily input, modify, or update speed constraints from the same integrated graphical display, thus reducing workload and potential errors. Ultimately, by enabling pilots to better manage the speed profile of their airplane, the SPMS helps pilots stay on the approved flight path for their airplane thus meeting several requirements such as but not limited to those related to fuel burn, emissions, noise restrictions, and traffic flow management.

The SPMS' graphical depiction of speed profile information accounts for the relationships the various types of information have with each other and to the overall approved flight plan in order to make the display more meaningful to the pilots. In this regard, the SPMS integrates information relevant to speed profile management such as computed and commanded speeds, airspace-related speeds, waypoints and associated speed constraints, or other speed profiles related to advanced Air Traffic Management (ATM) functions such as Continuous Descent Approaches (CDAs). The graphical depiction of the airplane's speed profile segments includes reinforcement of important speed profile information as a function of relevant flight segment markers such as top of climb, top of descent, waypoints, airspace boundaries, and flap settings, as well as, a reference for the airplane (own-ship) in relation to the speed profile graphical depiction.

In addition, interactive input capability of the SPMS includes selections for: phases of flight such as takeoff, climb, cruise, descent, approach, and landing; speed selection for calculated economic speed or pilot-selected speed; standard speed restriction as a function of airspace; additional speed restrictions as desired by pilots; waypoint-related speed constraints; scrolling device for viewing sequences of speed profile segments; and, input means for selecting and for keying-in speed-related information.

An embodiment of the disclosure on an airplane comprises a Speed Profile Management System (SPMS); a Flight Management System (FMS) operatively connected to the SPMS; a navigation system operatively connected to the SPMS; a cockpit graphical display system operatively connected to the SPMS; an aircraft control system operatively connected to the SPMS; a communications system operatively connected to the SPMS; a surveillance system operatively connected to the SPMS; a control input device operatively connected to the SPMS; and graphical display of speed profile information displayed on the cockpit graphical display system, including locations in the forward field of view.

A computer-implemented method of managing the speed profile of an airplane in accordance with another aspect of the disclosure includes receiving flight plan information, receiving aircraft state and intent information, calculating the speed profile of the airplane based on the received information, displaying the speed profile on an integrated and interactive graphical display for management by the flight crew, and transmitting the calculated speed profile to the aircraft control system to affect or change the speed of the airplane.

It should be appreciated that this Summary is provided to introduce selected aspects of the disclosure in a simplified form that are further described below in the Detailed Description. This Summary is not intended to be used to limit the scope of the claimed subject matter. Other aspects and features of the present disclosure, as defined solely by the claims, will become apparent to those ordinarily skilled in the art upon review of the following non-limited detailed description of the disclosure in conjunction with the accompanying figures.

### BRIEF DESCRIPTION OF THE DRAWINGS

FIG. 1 is a schematic diagram of an advantageous embodiment of the systems' components according to the disclosure.

FIG. 2 is an example of an aircraft control architecture entailing a speed control system.

FIG. 3 is a diagram illustrating a general arrangement of an aircraft cockpit.

FIG. 4 is a diagram illustrating a more detailed arrangement of cockpit instruments that enable an advantageous embodiment according to the disclosure.

FIG. 5 is a diagram showing a general layout of the SPMS display.

FIG. 6 is a diagram showing a more detailed layout of speed profile management functions.

FIG. 7 is a diagram illustrating further details of graphical speed profile management elements.

FIGS. 8 and 9 are diagrams illustrating speed profile control capabilities.

FIG. 10 is a flow chart of an example of a method of speed profile management in accordance with an embodiment of the present disclosure.

### DETAILED DESCRIPTION

The following disclosure describes methods and systems for receiving, processing, and managing the speed profile of an airplane. Certain specific details are set forth in the following description and the figures to provide a thorough understanding of the various embodiments of the disclosure. Well-known structures, systems, and methods often associated with aircraft control, display, and flight management systems have not been shown or described to avoid unnecessarily obscuring the description of the various embodiments of the disclosure. In addition, those of ordinary skill in the relevant art will understand that the additional embodiments of the present disclosure may be practiced without several of the details described below.

Many embodiments of the disclosure described below may take the form of computer-executable instructions, such as routines executed by a programmable computer. Those skilled in the relevant art will appreciate that the invention can be practiced on other computer system configurations as well. The disclosure can be embodied in a special-purpose computer or data processor that is specifically programmed, configured, or constructed to perform one or more of the computer-executable instructions described below. Accordingly, the term “computer” as generally used herein refers to any data processor that can be engaged in a cockpit, including computers for cockpit display systems, Flight Management Computers (FMC), Flight Control Computers (FCC), Electronic Flight Bags (EFB), laptops, laptops, or other hand-held devices.

The disclosure can also be practiced in distributed computing environments, in which tasks or modules are performed via remote processing devices that are linked through a communication network such as those enabled via datalink by the aircraft communication systems. In a distributed computing environment, program modules or subroutines may be located in both local and remote memory storage devices. Aspects of the disclosure described below may be stored or distributed on computer-readable media, including magnetic or optically readable computer disks (e.g., removable disks), as well as distributed electronically over networks. Data structures and transmission of data particular to aspects of the disclosure are also encompassed within the scope of the disclosure. Information handled in accordance with aspects of the disclosure can be presented at displays or display media, for example, CRT screens, LCD screens, heads-up displays, or other suitable devices.

Commanders and pilots of vehicles such as aircraft have the task of not only managing the complex systems of the aircraft but also operating the aircraft in a safe and efficient manner. In this regard, cockpit flight crews such as pilots are presented with a number of complex cockpit systems to manage myriad information that they must interpret in context with the task at hand, and ultimately utilize in making their decisions and executing their tasks based on those decisions.

For example, pilots generally utilize the Flight Management System (FMS) 14, which typically may entail a Flight Management Computer (FMC) (not shown) and a Control Display Unit (CDU) 96 for managing the (a) flight planning, (b) navigation, (c) performance, (d) guidance, and (e) datalink communication aspects of their flight. This entails, among others, planning, entering, and activating aspects of their flight for each phase of flight including take-off, climb, cruise, descent, approach, and landing.

With respect to flight guidance, pilots may utilize both the FMS 14 and the Mode Control Panel (MCP) 94 to manage aspects such as the lateral profile, the vertical profile, and the speed profile of the aircraft's flight. Input for managing these aspects may be made, for example among others, via the CDU 96, the MCP 94, or other interactive means such as touch-screen or cursor-control devices. The flight guidance input may be used to control the autopilot and related systems such as flight director systems, flight control computers, and autothrottle system that may in turn send commands to other airplane systems such as the engines and flight control systems to direct and control the airplane consistent with the pilots' commands.

Lastly, information pertinent to the aforementioned aspects (a)-(e) above may be displayed in a number of display locations on the aircraft such as the Primary Flight Displays (PFD) 82, Navigation Displays (ND) 84, Mode Control Panels (MCP) 94, Control Display Units (CDU) 96, and Crew Alerting Displays 86. This information may include, for example but not limited to, pilot-entered data, uplinked data, stored data from navigation databases (NDB) or Aerodynamic and Engine databases (AEDB), and actual data as processed or calculated for the current flight.

Thus pilots have to keep track of myriad information, information often originating from multiple sources and control authorities that displayed at multiple displays. Furthermore, they must filter the information for what may affect the current and/or planned phases of flight, make decisions, and manage the airplane's flight profile consistent with the required or desired performance for the flight.

This complexity of the pilots' challenge is manifold. In addition to the distributed nature of control and display aspects of the flight's management, there may be additional overriding inputs that the pilot must integrate into their flight management. Airplane system complexity can introduce overriding flight management functions such as engine-out performance limits or flight envelope protection regimes that constrain the flight profile of an airplane. In addition, constraints engaged by procedural limits such as but not limited to Continuous Descent Approaches (CDA), noise abatement procedures, or other traffic management related automated functions may also affect the flight profile of an airplane. Thus, as airplanes and the airspace environment in which they operate have evolved to become more complex, the pilots' tasks of managing their airplane's flight profiles have gotten more complex.

One aspect of flight profile whose management poses a challenge is speed. The use of more efficient and more sensitive/complex navigation procedures such as Required Navigation Performance (RNP)/RNAV; the availability of more options for fuel efficient, noise abatement, or throughput optimizing flight routings; and the application of automated navigation such as vertical navigation (VNAV) via autopilots to achieve fuel efficiency or required time of arrival (RTA) objectives, among others, all contribute to an increase in the need for speed management.

However, as cockpit automation has not kept up with the pace of increasing requirements discussed above, speed management is not a simple task for pilots. As discussed above, the speed profile of modern commercial aircraft is influenced by myriad input. Depending on the phase of flight, such as take-off, climb, cruise, descent, approach and landing, for example, such input may include the aircraft's speed capability and optimum economic performance given certain input constraints such as its configuration, available weather data, and required time of arrival. It also may be influenced by altitude-based restrictions such as a speed limit of 250 knots below 10,000 feet. Furthermore, an aircraft's speed may also be constrained by speed restrictions or constraints attached to waypoints that define its route. In addition, performance requirements related to new Air Traffic Management (ATM) functions such as Continuous Descent Approaches (CDA) or traffic applications where aircraft may follow each other at a certain gap measured in time, distance or speed, may also have to be factored in for the correct speed profile for an airplane.

In this regard, pilots may manage a number of speed constraints or aspects that may affect the speed profile of an aircraft. In addition to the aspects discussed above, particular speed constraints or inputs may include, without limitation, most economic speeds, long range cruise speeds, required time of arrival (RTA) speeds, company policy-based speeds, limit speeds such as flap limit or VMO, MMO etc., MCP speeds, crew selected speeds, and engine-out speeds.

The combination of these various types of speed inputs can result in a complicated speed schedule that can be difficult to manage utilizing the aforementioned multiple systems currently engaged in speed profile management. The sequence of speed restrictions, including overlapping ones that may override one another, make it harder for pilots to anticipate speed changes, understand the reasons for them when they occur, and ultimately manage them consistent with applicable requirements for the route, airspace, and the airplane's performance.

The need to monitor and utilize these different systems contributes to increased workload, and potentially to errors or anomalies. The errors and anomalies may result in impact to economic performance, reduction in situational awareness, inability to stay on an approved flight path, and potential disruption to air traffic flow on the airplane's route or the airspace through which the airplane is flying. Thus, there is a need for a tool that simplifies the flight crew's awareness and management of the airplane speed profile in all phases of flight.

The present disclosure addressed this need by providing a method and system that provides tools for an integrated graphical speed profile management system and associated controls. The tool provides, in a graphical display, relevant speed profile parameters for each phase of flight, as well as, the operating speed restrictions and modes for that particular phase of flight together with input means.

The benefits of this integrated graphical speed profile management system and associated controls clearly go beyond the ease of view provided by the arrangement. They also go beyond simply designing displays and controls to implement certain functions and are focused on an integration that optimizes the flight crew's awareness and management of the airplane's speed profile for increasingly complex aircraft operating in more complex airspace environments. Here, a non-exhaustive list of benefits by the way of prefatory overview may be helpful. Other benefits will be discussed later in the detailed description.

Among the several benefits is the ability to gain immediate feedback as to the changes to the speed profile that are made using the controls. Instead of crews making control input changes at disparate locations in the cockpit and then waiting for the changes to take effect, the effect sometimes being the actual change of the aircraft's speed at a later time, pilots can now input the desired speed changes and preview and evaluate the proposed change immediately on the SPMS 12. This has the added benefit of ensuring accuracy in the first instance to avoid the need to correct or adjust speed entries, thus reducing errors or giving the crew an opportunity to catch errors much earlier.

A further benefit is crew workload reduction. The preview mode provides the ability to see the speed profile of an upcoming phase of flight and make modifications to that phase of flight early on, thus potentially reducing workload or moving workload from a busy phase of flight to a less busy phase of flight. For example, crews can manage the speed profile of the descent phase of flight while in cruise when they are less busy than in descent when more flying and non-flying tasks demand more of their time.

Yet another benefit is that the SPMS 12 gives pilots an understanding of why speed changes are occurring. With the current systems, if the speed of an airplane changes because of flap settings, other configuration changes, an engagement of a flight procedure, and the like, the pilot may see the speed changes on an instrument but may not know or may not immediately recall why the speed changed. On airplanes with complex flight control and flight management systems, a pilot may also not immediately recall which control input among the several control inputs on the airplane effected the change. On airplanes equipped with an SPMS 12, however, a pilot may view the SPMS display to gain an immediate understanding of the speed profile of the airplane, as well as, the relevant speed constraints and restrictions that are affecting it.

Throughout this disclosure, speed profile refers to the speed of the aircraft for the different phases of flight or flight segments thereof. The speed that is managed via the SPMS 12 is generally the speed component of the forward velocity of the airplane and not the vertical speed of the airplane. The term speed refers to the airspeed of an airplane, and the two, speed and airspeed, may be used interchangeably. Furthermore, the type of airspeed such as calibrated airspeed (CAS), indicated airspeed (IAS), Mach number, groundspeed and the like is not specifically called out as it is not critical to teaching the invention. Any type of airspeed may be displayed on the SPMS 12 that is consistent with the airspeed displayed in other cockpit instruments.

In addition, units for airspeed, altitude, or the like are provided as non-limiting examples only. With respect to terms such as “speed restriction” and “speed constraint”, the important point being conveyed is the limitation on speed associated with, for example, an altitude or a waypoint. Although the disclosure generally uses the term constraint for speed limits associated with waypoints and generally uses the term restriction for speed limits associated with altitude or airplane configuration, the two terms may be used interchangeably. There is no loss of meaning intended or implied if one term is used and not the other.

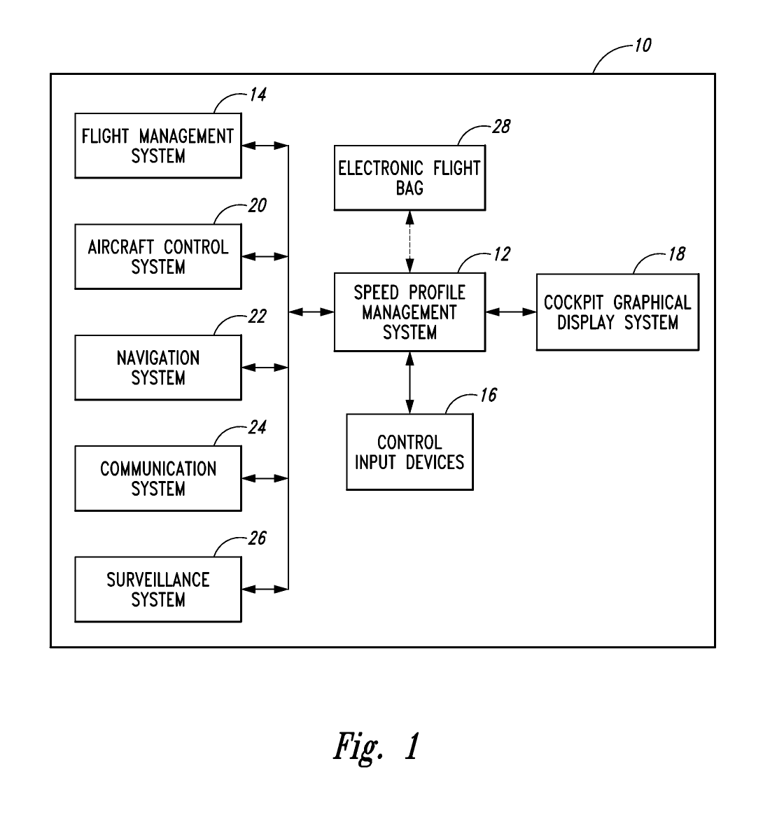

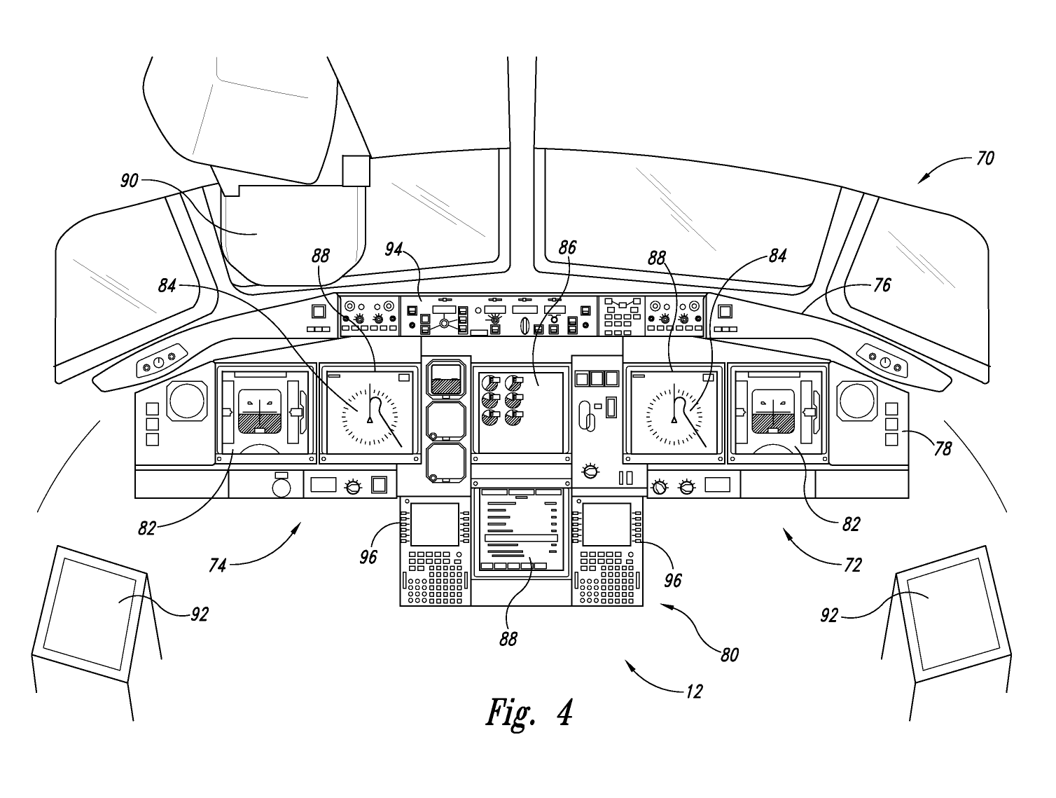

FIG. 1 depicts an embodiment of a generalized aircraft systems architecture 10 centered on a Speed Profile Management System (SPMS) 12. FIG. 1 has been simplified in order to make it easier to understand the present disclosure. Those skilled in the art will appreciate that FIG. 1 is one configuration of many that can be implemented for an embodiment of an SPMS 12. For example, and without limitation, the SPMS 12 can be hosted on a number of on-board computers suitable for the airplane configuration at hand such as a dedicated SPMS computer (not shown), a Flight Management System (FMS) 28, or a cockpit graphical display system (CGDS) 18, which typically comprises at least a graphics display computer (not shown) and a graphics display (not shown). With respect to displays, in various embodiments as shown in FIG. 4, an aircraft cockpit 100 and the airplane's cockpit graphical display system 18 may include at least one of a Primary Flight Display (PFD) 82, a Navigation Display (ND) 84, a Head-Up Display (HUD) 90, a Multi-Function Display (MFD) 88, a Crew Alerting Display 86, and an Electronic Flight Bag (EFB) display 92, or other displays in the cockpit.

Referring to FIG. 1, an SPMS 12 is provided to manage the speed profile of an airplane. From the available information in the cockpit affecting all aspects of the speed profile of the airplane, the SPMS 12 extracts the information from the interfacing systems described in FIG. 1 and makes it available to the flight crew on the SPMS 12 display displayed on a Cockpit Graphical Display System (CGDS) 18. The SPMS 12 also transmits information that has been modified, changed or updated by the flight crew using the SPMS' 12 interactive capability, and potentially other Control Input Devices 16 affecting speed profile back to the systems shown in FIG. 1 to affect the speed of the airplane.

In this regard, the Aircraft Control Systems 20 (components of the aircraft flight control system not shown) provides speed-profile relevant information such as the performance and health of the engines, flight control computers, autopilot and autothrust systems, and selected flight control inputs on the Mode Control Panel (MCP) 94 (shown in FIG. 4). It also receives speed-profile relevant commands from the SPMS 12, the MCP 94, or other systems and directs them to its component systems, such as for example, the autothrottle and engines, to affect the speed of the airplane.

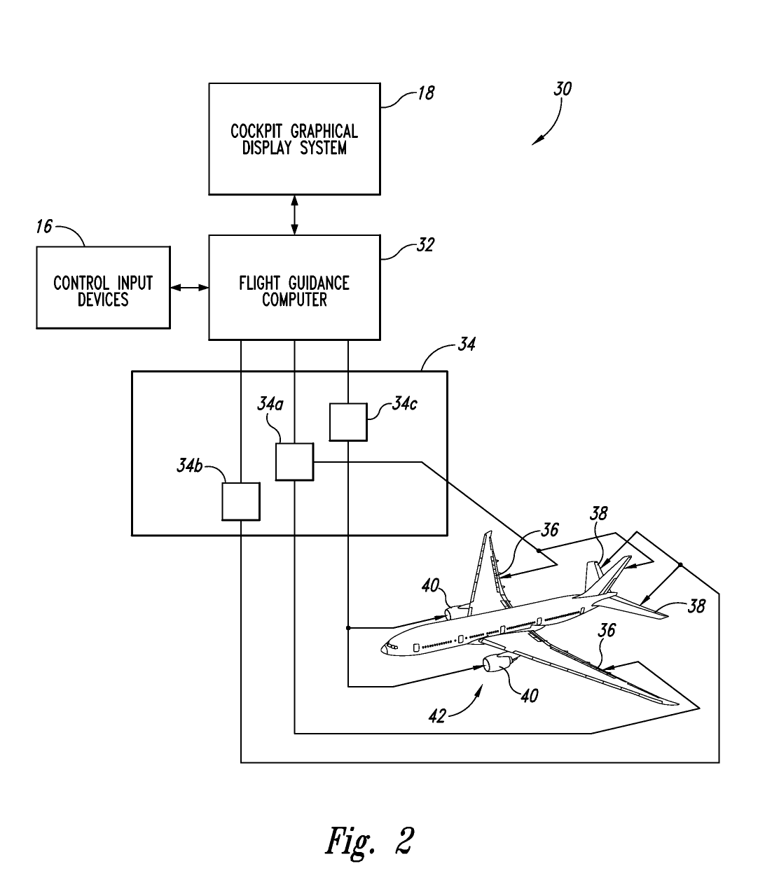

Aspects of the flight control system have been described in further detail previously, an example of which may be found in U.S. Pat. No. 7,460,029 B2. For example, as shown in FIG. 2, a flight guidance system 30 that is an embodiment of Aircraft Control System 20, may entail display devices such as a Cockpit Graphical Display System 18 or other Annunciators (not shown), Control Input Devices 16, a flight guidance computer 32, linked to one or more control systems 34, shown as a lateral/directional motion or roll/yaw control system 34a, a vertical motion or pitch control system 34b, and an airspeed (or autothrottle/engine) control system 34c. The lateral/directional control system 34a can be coupled to flight control surfaces affecting lateral and directional control 36, which are typically ailerons and/or rudders of the airplane 42. The vertical motion control system 34b can be coupled to pitch control surfaces 38, which are typically the aircraft's elevators. Lastly, the airspeed controller 34c can be coupled to the engines 40 of the airplane 42 in some path-based modes of operation, and can be coupled to the elevators in some climb and descent modes of operation.

Returning to FIG. 1, the Flight Management System (FMS) 14, and its Navigation database (NDB) (not shown) and Aerodynamic and Engine (performance) database (AEDB) (not shown) provide information necessary for navigation along the four-dimensional (4D) flight route for calculating the optimal or desired performance for that flight route. The FMS 14 and its lateral and vertical navigation guidance functions may also utilize information from Navigation System 22, Communication System 24, and Aircraft Flight Control System 20 and display flight management information a Cockpit Graphical Display System (CGDS) 18.

The Communications System 24 may also be enabled to uplink and downlink information, for example and without limitation, related to flight plans, Air Traffic Control (ATC) instructions for lateral navigation, vertical navigation, speed changes, required time of arrival at a waypoint, required time of arrival at a destination, weather, or Airline Operational Control (AOC) messages such as those related to gate information and updated time of arrival. It may also be engaged in transmitting and receiving coordination messages between aircraft that are engaged in a collaborative Air Traffic Management (ATM) application such as where one aircraft is asked to follow another aircraft at a certain distance, time, speed or altitude parameters.

Another important system in managing the speed related aspects of a flight is the airplane's Navigation System 22. Its component systems such as the Global Positioning System (GPS), Distance Measuring Equipment (DME), VHF Omni-Directional Range (VOR), Air Data and Inertial Reference Unit (ADIRU), Air Traffic Control (ATC) Transponders, Traffic Alert and Collision Avoidance System (TCAS) and/or other traffic computers used for Air Traffic Management (ATM) applications provide speed-profile relevant information as related to, for example and without limitation, the navigation or guidance performance of the aircraft in reference to its flight plan, a navigation station or waypoint, or to some objective as set forth by a procedure such as a Continuous Descent Approach (CDA) or a collaborative Air Traffic Management (ATM) application. In this regard, certain ATM applications may be available as part of the Surveillance System 26. Alternative configurations may also embody ATM applications and certain navigation information in a suitably equipped Electronic Flight Bag (EFB) 28 that may interface with the SPMS 12.

In addition, Control Input Devices 16 are provided to enter, accept, and utilize speed-profile relevant information that is available from, without limitation, a communications uplink from Air Traffic Control (ATC) or an Airline Operational Center (AOC) the Communication System 24, a paper chart, customized airline-specific approach procedure database, or other on-board aircraft systems such as the Aircraft Control System 20, the Flight Management System 14, the Navigation System 22, or the Surveillance System 26. The Control Input Devices 16 may also be utilized to manage the display of information provided by the SPMS 12. For example, the devices 16 may be used to command the SPMS 12 to pop-up SPMS graphical information as a function of when the aircraft is about to change its speed. It may also be used to add or remove certain data tags associated with the graphical elements displayed on the SPMS 12 so that pilots may be able to customize their speed profile management display.

Lastly, the Control Input Devices 16 may be embodied as a dedicated control panel or as part of another control input device on the airplane. For example, and without limitation, the device 16 may be integrated as part of the Control Display Unit (CDU) 96, or as part of another control panel for controlling flight management, navigation or display aspects of the aircraft's systems. Further, the devices 16 may include, without limitation, voice command input means, keyboards, cursor control devices, touch-screen input and line select keys (LSK) or other keys on a CDU 96.

The above detailed description of FIGS. 1 and 2 are intended to describe one embodiment but not the only embodiment of this disclosure, and in no way limit the scope of the disclosure. While the components of the systems such as those depicted in FIG. 1 can be designed to interact with each other in a variety of ways, they must in the end be helpful to the pilot in managing the speed profile of the airplane. The SPMS 12 is configured to continuously update the integrated speed profile information as described below.

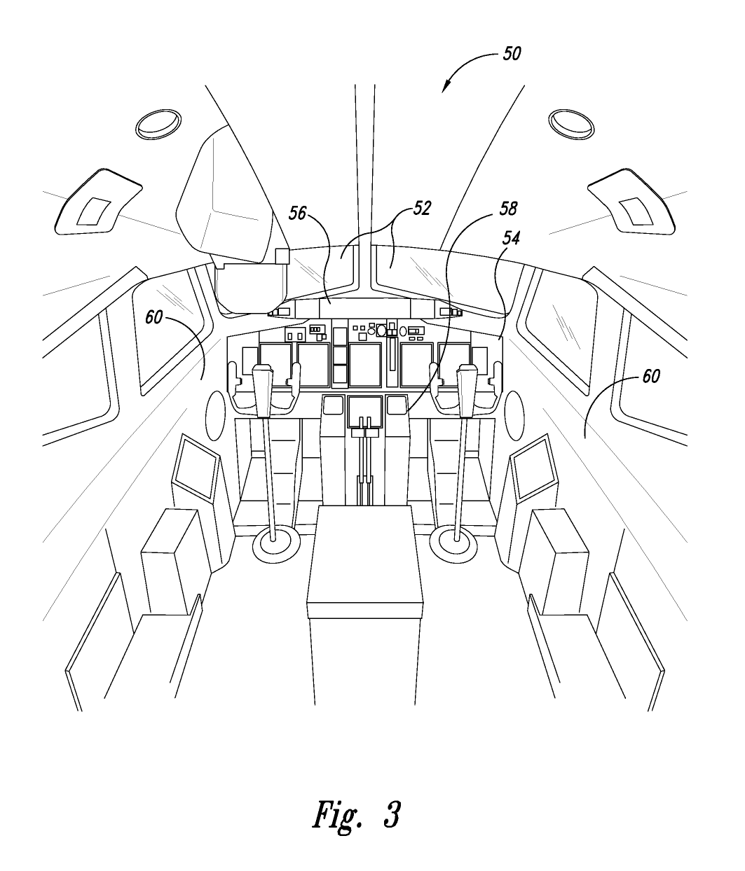

FIG. 3 illustrates a general arrangement of an aircraft cockpit 50 showing a layout of many of the aircraft systems that interact with the SPMS 12, which are shown in further detail in FIG. 4. The cockpit 50 includes forward windows 52 a plurality of flight instruments on the forward instrument panel 54, a glare shield 56, a control pedestal 58, and sidewalls 60.

FIG. 4 shows a close-up view of the cockpit 70 with a glare shield 76, a forward instrument panel 78, and a control pedestal 80 with various instruments 72 and displays 74. The forward instrument panel 78 and the control pedestal 80 have a number of displays, including multifunction displays 88. As shown here, the multifunction displays 88 include a Primary Flight Display 82, a Navigation Display 84, and a Crew Alerting Display 86. The multifunction display 88 on the control pedestal 80 may also be configured to manage datalink communications or other cockpit functions. In addition, the cockpit has a Head-up Display 90, a Control Display Unit (CDU) 96, and an Electronic Flight Bag display 92. All of the aforementioned systems, which in display-oriented functional aspects may be part of the Cockpit Graphical Display System 18, can potentially be used in displaying or hosting some or all aspects of SPMS 12.

Lastly, a Mode Control Panel (MCP) 94 is positioned on the glare shield 76. The MCP 94 along with the CDU 96 and multifunction displays 88 with interactive capability may be capable of controlling or modifying inputs that influence the speed profile of the airplane.

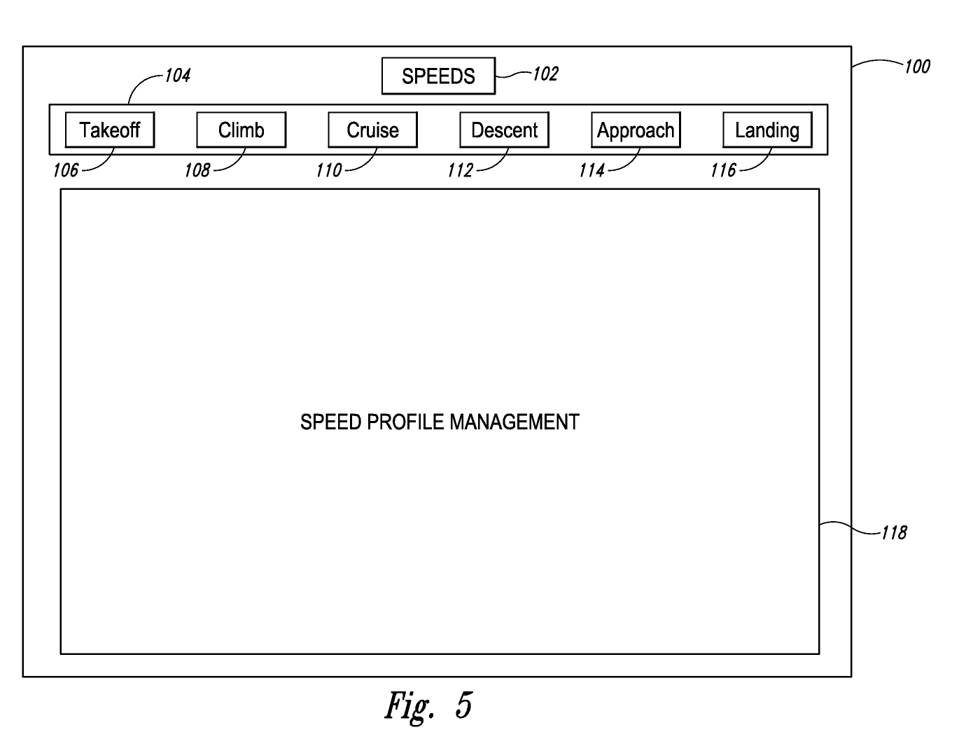

FIG. 5, drawn not to scale for illustrative purposes, depicts an embodiment of an interactive SPMS display 100. The display allows for a quick, efficient, graphically integrated, and simplified speed profile management by the flight crew. The display may be shown on any Cockpit Graphical Display System 18 display devices with interactive capability. Furthermore, one of the advantages of the SPMS′ depiction of a simplified speed profile is that it can be shown on a portion of a display device, a single display device, or on multiple display devices.

Here, it may be helpful to break down the number of display elements by category. It should be appreciated that the display elements described below may be further coded by color, shape, attributes or other visual indicators and potentially, accompanied by aural tones or annunciations depending on the critical nature of the information. Furthermore, the data presented in the figures, which may be slightly modified versions of available data on other displays or data not previously provided at all, are provided by the way of example only and should not be construed as limiting. Lastly, any combination or sub-combination of graphical elements provided in this disclosure may be available for display; the combinations provided in figures are provided by the way of example and not limitation.

As the SPMS display 100 may be hosted on a number of display devises, and potentially as part of a series of flight management pages or functions, the SPMS page is identified by a header or page titled, SPEED MANAGEMENT or SPEEDS 102. To enable speed management for each phase of flight, for example, the current phase of flight or a future or planned phase of flight, the SPMS has a Phase of Flight Selector (PFS) 104. The PFS 104 may show all the relevant phases of flight where the speed profile of the aircraft can be managed such as takeoff, climb, cruise, descent, approach, and landing. If desired, additional phases of flight such as go-around (not shown) may also be implemented. The PFS 104 further comprises a selector for each phase of flight. As shown in FIG. 5, the PFS 104 has a Takeoff selector 106, a Climb selector 108, a Cruise selector 110, a Descent selector 112, an Approach selector 114, and a Landing selector 116. Speed Profile Management (SPM) tools 118 are placed below the PFS 104.

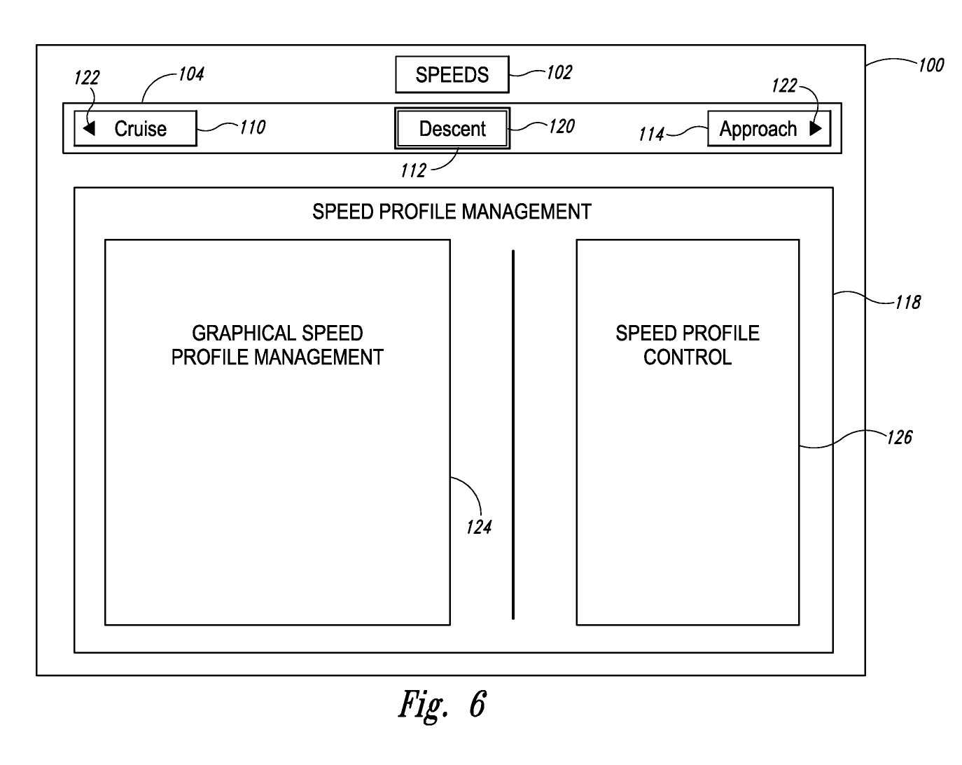

As shown in FIG. 6, the PFS 104 can also be configured to present the active page 120 with the preceding and next phases of flight selectors shown with page change icons 122. For example, in FIG. 6, the PFS 104 shows the Descent page 112 as the active page 120 identified with a double box or other distinguishing markers, the Cruise page 110 as the preceding phase of flight and the Approach page 122 as the next phase of flight. The active page 120 is the page that has the capability to manage the phase of flight that is currently being displayed.

The active page can be engaged in two ways. First, the active page 120 enables speed profile management for the current phase of flight. That is, for example and without limitation, when the airplane is in the descent phase of flight, the crew can use the Speed Profile Management Tools 118 for the current, active phase to manage the speed profile of their airplane in the descent phase of flight.

Second, the active page 120 may also be engaged to enable speed profile management for an upcoming phase of flight. For example, while the airplane is in the descent phase of flight, selecting Approach 114 will make Approach 114 the active page 120. The crew may then preview the speed profile for the approach phase, and if desired, make appropriate modifications to the speed profile for the approach phase while still in descent.

Yet another feature of the active page 120 is that it enables pilots to view or review the speed profile of their airplane for a completed or past phase of flight. Lastly, PFS 104 aspects of the disclosure can be embodied with or without all of the different phase of flight selectors, 106-116.

Still referring to FIG. 6, Speed Profile Management (SPM) tools 118 are situated below the PFS 104. The SPM tools 118 comprise of graphical speed profile management portion 124 and speed profile control 126 portion. The graphical speed profile management portion 124 integrates speed profile related data and interactively display the speed profile of the aircraft for the selected phase of flight. The speed profile control portion 126 provides enhanced interactive tools to enter, modify, or update the speed profile of the selected phase of flight as shown graphically on the graphical speed profile management 124 portion. Together, the graphical speed profile management portion 124 and the speed profile control portion 126 provide an integrated depiction of the speed profile of the aircraft for the active page 120 in one cockpit display that can be understood, modified, and updated easily.

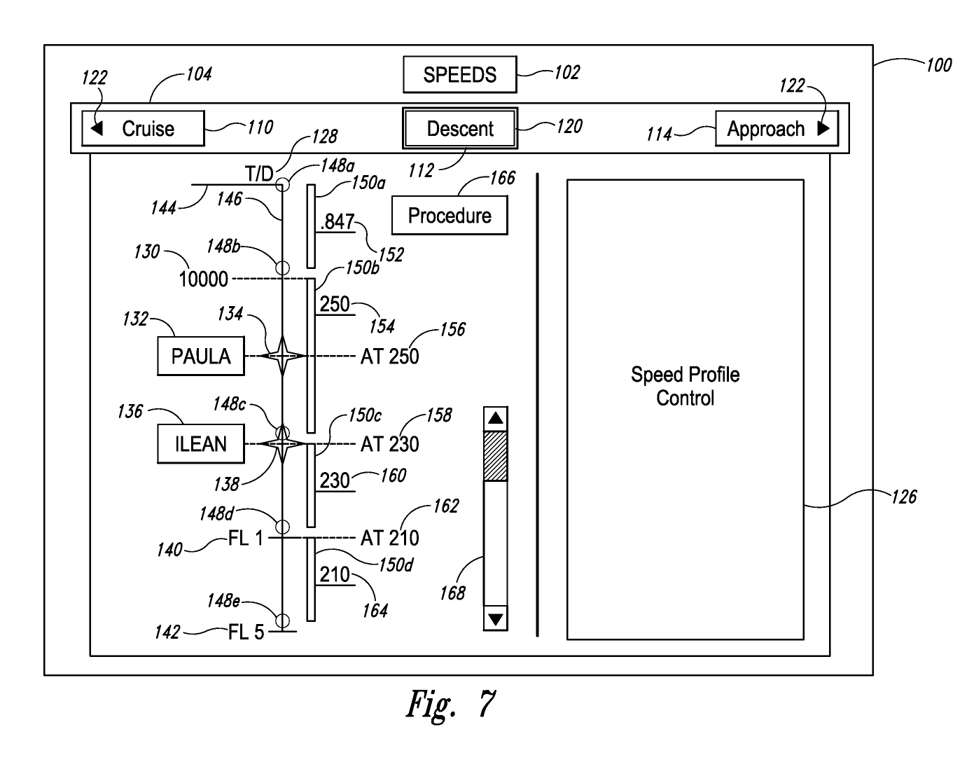

FIG. 7, drawn not to scale for illustrative purposes, depicts one embodiment of graphical speed profile management portion 124 for the descent phase of flight. As stated earlier, those of ordinary skill in the art will appreciate that FIG. 7 depicts one preferred configuration of many that can be implemented to embody a speed profile management tool. Depictions for the other phases of flight can be similarly embodied and will not be repeated. All structurally similar depictions for other phases of flight such as climb or cruise, essentially utilizing similar elements as described in FIG. 7 are within the scope of the disclosure. The person of ordinary skill in the art can apply the teachings of FIG. 7 to embody similar depictions for the climb, cruise, or other phases of flight.

Referring to FIG. 7, the last portion of the cruise phase of flight is represented by a cruise phase of flight indicator 144. The cruise phase of flight indicator 144 may be shown as depicted or may start from the last waypoint and continue to the end of that phase of flight, such as a top of descent (T/D) label 128. The top of descent label 128 is accompanied by a speed command change indicator 148a, which indicates a change in the commanded speed of the aircraft. Speed command change indicators 148a, 148b, 148c, 148d, and 148e are shown at various points along the flight profile of the aircraft.

The descent phase of flight is represented by a descent phase of flight indicator 146, which continues downward from T/D 128 to the beginning of the approach phase of flight (not shown). Significant altitudes that define the boundaries of altitude-based speed restrictions such as 10,000 feet are indicated by speed restriction altitude indicators 130. The speed restriction altitude indicator 130 is not always linked to 10,000 feet. It could be any speed restriction altitude for a particular airspace or for a particular airline. For example, a flight to New York with a “250 knots at or below 10,000 ft” speed restriction, may show 10,000 for speed restriction altitude indicator 130 and a flight to another city X may show a value of 15,000 for a speed restriction altitude indicator 130.

Parallel to the descent phase of flight indicator 146 are a series of speed segment indicators 150a, 150b, 150c, 150d, representing the speed profile of the airplane for that segment of the descent. For example, from T/D 128 to a point prior to 10,000 ft at which the next speed command takes effect, the airplane flies at Mach 0.847 as shown by the segment speed readout 152 with speed transition beginning at 148b and reaching 250 knots at 10,000 ft. From an altitude of 10,000 feet the airplane flies at 250 knots as indicated by the segment speed readout 154 all the way down to speed command change indicator 148c where a speed transition begins.

Still referring to FIG. 7, waypoint name indicators 132, 136 which also serve as interactive buttons and waypoint symbol 134, 138 may also be shown together with waypoint speed constraints 156, 158 at those waypoints respectively. For example, as shown in FIG. 7, at waypoint PAULA indicated by the waypoint name indicator 132 and waypoint symbol 134, the airplane's speed needs to be 250 knots as shown on the waypoint speed constraint 156. Similarly, at waypoint ILEAN indicated by the waypoint name indicator 136 and associated waypoint symbol 138, the airplane's speed needs to be 230 knots as shown on the waypoint speed constraint 158. Thus, the speed segment indicator 150c, which starts at waypoint ILEAN, shows segment speed readout 160 with a value of 230 knots.

The graphical speed profile management tool 124 may also show speed restrictions as a function of aircraft configuration such as, for example and without limitation, flap settings, landing gear deployment, and engine out conditions. One example of configuration indicators 140, 142, is flap setting. Associated with configuration indicator 140 is configuration-based speed restriction 162. Here, configuration-based speed restriction indicator 162 has an associated segment speed readout 164 of 210 knots for aircraft configuration setting of Flaps 1. Using the scroll bar 168, a pilot is able to scroll down and see the associated speed restriction (not shown) for configuration indicator 142.

It is important to note the breadth of this disclosure with regard to how configuration indicators 140, 142 and configuration-based speed restrictions 162 are managed. Increasingly complex modern aircraft have highly automated flight control functions that may affect the speed of the aircraft when configurations changes with the aircraft occur. An aircraft on autopilot, for example and without limitation, may change speed due to engine out condition, flap asymmetry in flap deployment, or loss of control authority over one or more flight control surfaces. When such configuration changes occur, the autopilot may adjust the speed of the aircraft in order to maintain steady flight or other flight performance objective. The SPMS 12 can manage such speed profile changes and display them utilizing configuration indicators 140 and configuration based speed restrictions 162. Although the example here uses flap setting configurations, the SPMS 12 may also display other configuration indicators such as engine outs or other configuration conditions. In this regard, the SPMS 12 helps pilots to better understand when unscheduled speed changes occur and the reasons why they occur, thus avoiding surprises and increasing awareness of overall performance of the airplane.

Yet another advantage of the SPMS 12 is its management of speed profile information with respect to flight procedures. The procedure indicator 166 may show the flight procedure engaged that is controlling the speed profile of the airplane. For example, the flight procedure engaged for descent may be a Continuous Descent Approach (CDA) where the airplane makes an idle descent down to an airport. The speed profile displayed for the flight will then match the speed profile needed for a CDA to a particular airport. Other examples such as noise abatement procedures for climb-outs may also be managed from the Climb phase of flight page 108 where the noise abatement procedure name will be reflected in the procedure indicator 166 and a corresponding noise abatement speed profile will be graphically displayed.

The speed profile may also be the result of a combination of procedures, such as an arrival (e.g., STAR—Standard Terminal Arrival Route) and an approach, or it could be the result of an arrival selected from the navigation database (NDB), then modified extensively by the crew. In cases such as this where a single label may not be sufficient to describe the procedure behind the speed profile, multiple procedure labels or other nomenclature indicating the combination may be displayed on the procedure indicator 166.

Yet another example may be an Air Traffic Management (ATM) application where the airplane is being maneuvered manually or via autopilot-assisted ATM application for a certain objective such as maintaining a desired separation in time, distance, or altitude, which may in turn affect the speed profile of the airplane. In this case, the engaged procedure will be shown on the procedure indicator 166 and the corresponding speed profile will be graphically displayed. For example, if the ATM application's objective is to maintain a certain distance from a leading airplane, the speed segment readout 152, 154, 160, 164 may be dynamically updated such that pilots are aware that the speed is changing because of the procedure being executed as shown in the procedure indicator 166.

Appropriate indicators via colors or other textual and graphical symbology may be utilized on the speed segment indicator 150(a)-(d) to show that the speed segment has variable speed readout 152, 154, 160, 164 controlled by the procedure shown in the procedure indicator 166. For example, if the airplane is following another aircraft between T/D 128 and 10000 ft, the speed segment readout 152 showing 0.847 Mach may show additional information such as VAR IN-TRAIL to indicate that the airplane is trailing behind another aircraft and that the speed is variable. IN-TRAIL may also be shown on the procedure indicator 166.

As stated earlier, the SPMS 12 may be used to manage the speed profile of the current phase of flight, review the speed profile of a past phase of flight, and preview the speed profile of an upcoming phase of flight. For example, while the airplane is in cruise, pilots may preview the descent phase of flight by selecting and making the Descent phase of flight page 112 the active page 120. By previewing the descent phase of flight, pilots may, for example and without limitation, preview their expected speed profile for descent. Alternatively, they may also preview a speed profile of a procedure they expect to engage such as a Continuous Descent Approach (CDA) by selecting or entering the procedure in the procedure indicator 166. Thus, not only does the SPMS 12 help pilots manage the speed profile of the active phase of flight, it also helps pilots get familiarized with speed profiles of upcoming phases of flight, as well as, speed profiles as a function of various flight procedures.

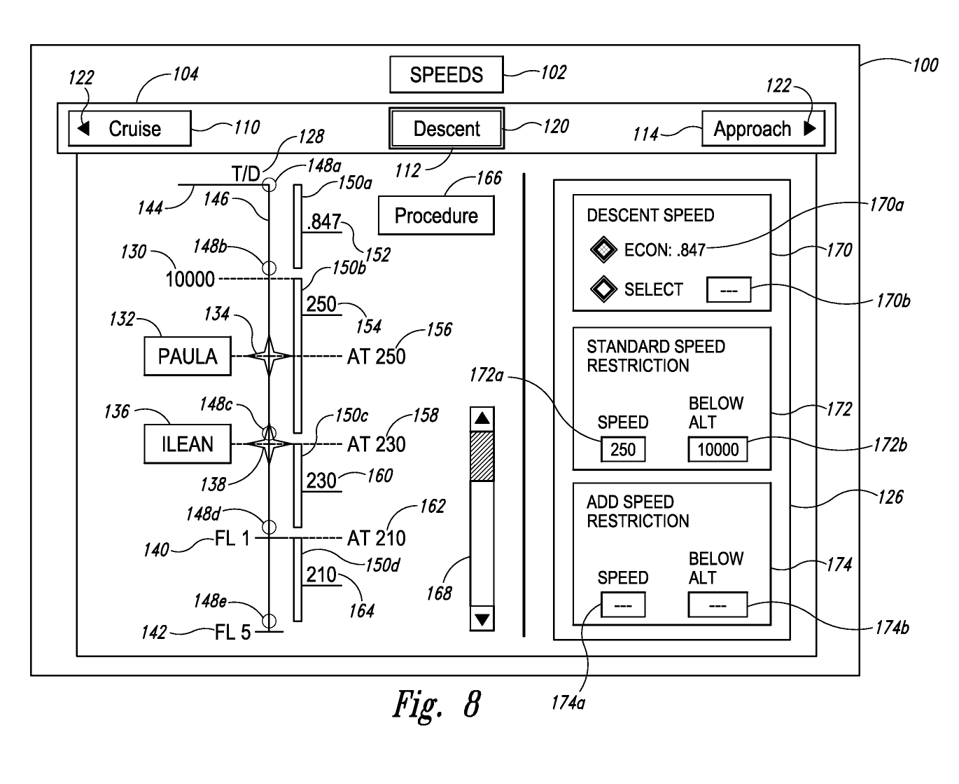

FIG. 8 provides further details for an embodiment of speed profile control 126 tools. As stated earlier, those of ordinary skill in the art will appreciate that FIG. 8 depicts one preferred configuration of many that can be implemented to embody a speed profile control tools. Enhancements such as rearrangement of the elements or addition of colors and symbols are within the scope of this disclosure.

Now referring to FIG. 8, the controls for nominal descent speed are provided by the descent speed selector 170. The pilot may select the economic speed 170a via a cursor control device, or have the economic speed selected as a function of a previously stored flight plan parameter. The economic speed is a speed, generally calculated by the FMC, to optimize a certain cost index or parameter such that the airplane executes the descent for minimum time, minimum fuel, an optimal balance of these two factors for best economy, or some other criterion. The economic speed is displayed in the field and a radio button associated with the economic speed field is highlighted. Alternatively, the pilot may choose to select a different descent speed by entering a pilot-selected speed in the selected speed field 170b. In this case, the speed entered is displayed in the field and the radio button associated with the selected speed field is highlighted.

The descent speed may be modified by a number of speed restrictions as discussed above. The number of speed restrictions can be managed via the speed profile control 126 tools. Standard speed restrictions, for example and without limitation, altitude-based speed restrictions such as “250 knots at or below 10,000 feet” can be controlled via the standard speed restriction selector 172. The pilot may enter the desired speed in the speed field 172a and the altitude below which the speed restriction applies in the altitude field 172b. Additional speed restrictions that may engage at different altitudes can also be managed by the additional speed restriction 174 selector. The additional speed restriction 174 selector works in a similar manner as the standard speed restriction selector 172, with corresponding speed field 174a and altitude field 174b.

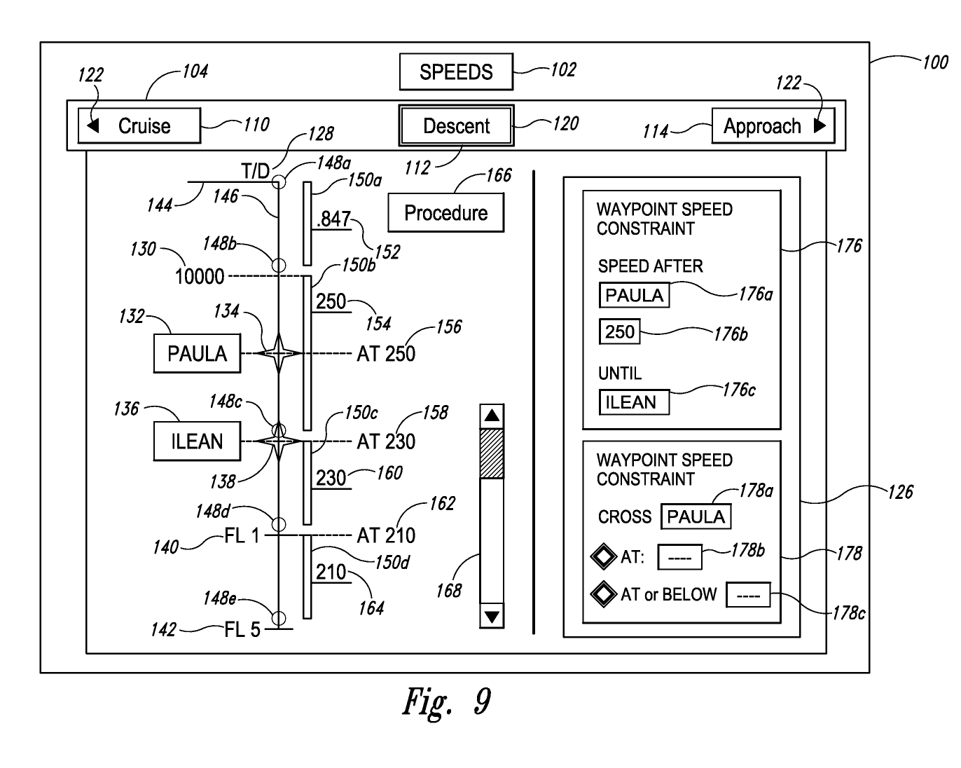

Lastly, the speed profile of an airplane may also be constrained by a waypoint-related speed constraint or restriction. A non-limiting illustration of how waypoint-related speed constraints are managed can be demonstrated via FIGS. 8 and 9. To manage a waypoint-related speed constraint, a pilot may select the waypoint. For example as shown on FIG. 8, a pilot seeking to manage the speed constraint related to the waypoint PAULA selects the waypoint name indicator 132 PAULA via a cursor control device. When the selection occurs, the speed profile control 126 portion of the display changes to the display shown in FIG. 9 where a waypoint speed constraint selector 176 is displayed. The waypoint speed constraint selector 176 has a waypoint identifier 176a, a speed field 176b at which speed the airplane is to fly after the waypoint, and a limit field 176c, which in this case is waypoint ILEAN, until which the waypoint-related speed constraint operates.

The limit field may or may not be another waypoint. It could, for example and without limitation, be a standard speed restriction, an altitude-based speed restriction, or a configuration-based speed restriction. For example, a speed constraint at ILEAN may be entered to operate until flaps are deployed.

Selecting the waypoint name indicator 132, in addition to displaying the waypoint speed constraint selector 176, can also display waypoint speed constraint selector 178. This alternative way of managing waypoint speed constraints, which may be more useful for the descent phase of flight, has a waypoint identifier 178a; a radio button and a first speed field 178b to input the speed at which the airplane crosses the waypoint PAULA; and a radio button and second speed field 178c that designates the speed at or below which the airplane crosses the waypoint PAULA.

Those of ordinary skill in the art will appreciate that the information supporting the graphical speed profile management comes from various sources on board the aircraft. By the way of example, and without limitation, waypoint information may come from the Flight Management System (FMS) 14 and the Navigation System 22. Standard speed restrictions may come from an uplink from Air Traffic Control via the Communications System 24, optionally routed via the Flight Management System 14. Configuration-based speed restrictions may come from the Aircraft Control System 20, the Flight Management System 14, or other systems that provide configuration information. Speed restrictions that operate as a function of Air Traffic Management (ATM) applications may also come from a number of systems including the Surveillance System 26 or other systems such as the Electronic Flight Bag (EFB) 28 that may host an ATM application. Speed restrictions that become operative when the flight crew engages a flight procedure such as noise abatement may be provided by the Flight Management System (FMS) 14. Lastly, crew-entered speed restrictions may come from the MCP 94, an FMS 14 function, or the SPMS 12 speed profile control inputs 126.

As shown in FIGS. 7-9, the SPMS 12 brings together speed-profile-relevant information available from the various sources shown in FIG. 1 into a well-integrated, and simplified interactive graphical speed profile management and control tool. Thus, changes in speed profile can concisely and clearly be reflected by the graphical depiction of the SPMS 12. In this manner, pilots can look to one display and gain a very clear picture of the speed profile of the current phase of flight, preview the speed profile of an upcoming phase of flight, and modify or update the current or upcoming speed profile as needed to meet their performance objectives.

Yet another benefit of the SPMS 12 is the interactive input and control capability that is integrated with speed profile management. Pilots gain immediate visual feedback on the left-hand side of the display as they enter or update speed restrictions on the right-hand side of the display. In addition, the interactive input capability enables cockpit flight crew to plan the next phase of flight using graphical means before that phase of flight commences.

It is important to note that one of the salient features of the SPMS' 12 advantage is that the graphical scenario depicted is substantially independent of the number of systems that operate to affect the speed profile of the aircraft. Overlapping speed constraints such as altitude, waypoint, configuration, ATM application, and/or procedure-related speed restrictions and the attendant speed profile manifestation(s) can be displayed in one display using substantially the same graphical depiction. No matter what of the aforementioned list of restrictions is operating to affect the speed profile of the airplane, the presentation to the pilot remains substantially similar resulting in a familiarity that reduces workload and reduces the potential for errors.

A further benefit of the SPMS 12 is that it enables pilots to compare speed profiles of at least two flight profiles. For example, pilots may use the SPMS 12 to compare the speed profile of the descent phase of a first procedure, such as a Continuous Descent Approach (CDA), to that of the speed profile of a second procedure such as the descent phase of non-CDA, airline policy-based flight plan. The graphical depiction may be made one at a time such as first displaying the primary procedure and then displaying the secondary procedure, it may be displayed as a superposition of the speed profiles, or it may be displayed as a side-by-side comparison such that pilots can get a relative sense of the impact of changing procedures. Once the at least two speed profiles are made available for comparison as described above, the pilot may select and engage the speed profile most suitable for the task at hand by executing the preferred procedure.

Similarly, the system can be used to graphically show the speed profile of the current flight plan and the speed profile of a modified flight plan so that the pilots can compare the associated speed profiles of the current and modified flight plans respectively. The two speed profiles may be distinguished from each other via colors, graphical symbols, alphanumeric text or other differentiators. If after review and comparison the modified flight plan is executed, then the modified flight plan becomes the current flight plan that is providing aircraft control commands and its associated speed profile will be displayed.

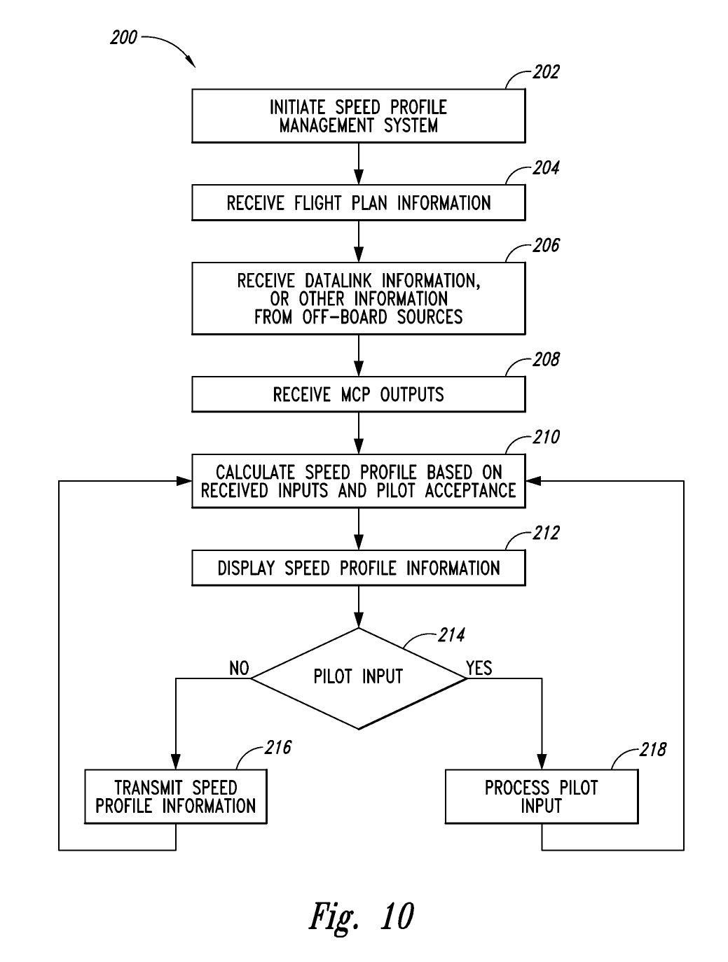

FIG. 10 depicts a general method 200 by which the disclosure may be implemented. The display of graphical information on display systems such as those utilized by pilots in a modern aircraft display system, including the storage and retrieval of certain information such as approach procedures in support of flight displays, have been previously implemented in industry. Those skilled in the art would understand how the placement of display symbology as well as storage and retrieval of approach procedures would be accomplished on aircraft systems, and that the depiction herein is one of several possible methods of displaying symbology.

It should be appreciated that the logical operations described herein are implemented (1) as a sequence of computer implemented acts or program modules running on a computing system such as a Flight Management Computer (FMC) and/or (2) as interconnected machine logic circuits or circuit modules within the computing system. The implementation is a matter of choice dependent on the performance and other requirements of the computing system. Accordingly, the logical operations described herein are referred to variously as steps, operations, or acts. These states, operations, or acts, may be implemented in software, in firmware, in special purpose digital logic, and any combination thereof. It should also be appreciated that more or fewer operations may be performed than shown in the figures and described herein. These operations may also be performed in a different order than those described herein.

As will be appreciated by one of skill in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Now referring to FIG. 10, first, a pilot initiates the SPMS 202. Alternatively, an on-board computer may automatically initiate the SPMS 202 as a function of phase of flight or other suitable context-sensitive criterion. This initiation step may entail simply turning on the system; choosing the SPMS 12 from a plurality of available flight management applications; making or confirming a plurality of selections via a control input device 16; or providing the SPMS 12 additional information from another system such as the Flight Management System (FMS) 14, the Navigation System 22, the Communication System 24, or the Surveillance System 26.

Next, the SPMS 12 receives information generally related to the aircraft's state information including current flight operating parameters and aircraft intent information including information pertaining to what the aircraft is commanded to do at a later time. This information also includes a number of speed-related data elements or information wherein the order of reception is not critical. The reception process is continuous until stopped; thus the system is continuously updated with the latest speed-related data elements. Such information is typically provided via digital data bus from each onboard system providing input to the SPMS 12. This is done today on many types of modern jet aircraft such as the Boeing 777 and the person skilled in the art would understand how such reporting is implemented.

The SPMS 12 receives flight plan information 204 and other data such as origin and destination airports, waypoints, and alternate flight plans from the Flight Management System (FMS) 14, its Navigation Database (NDB), its Aerodynamic and Engine databases (AEDB), or another suitable system or subsystem.

Furthermore, the SPMS 12 receives various types of information from off-board sources 206 via its interfacing systems as shown in FIG. 1. For example, it may receive communication (datalink) information from the Communication System 24 or another suitable subsystem. It may also receive traffic information from the Surveillance System 26, for example, airplanes in the vicinity with whom the pilot is coordinating one or more of the airplane's dynamic parameters such as speed and separation distance. With respect to information from off-board sources, it is important to note that lack of some or all of this information may not necessarily hamper functionality defined in subsequent steps. For example, if datalink information is not available or not required, the method may continue to step 208.

In Step 208, the SPMS 12 receives information related to flight guidance and/or autopilot modes and commands from the Mode Control Panel (MCP) 94.

In Step 210, the SPMS 12 processes the received information, calculates the speed profile of the airplane based on some or all of the aforementioned received information in Steps 204-210, and processes the speed data for display as a function of altitude, waypoints, airplane configuration and associated speed constraints respectively.

In Step 212, the SPMS 12 displays speed profile information on a suitable cockpit display in a manner substantially similar to what is displayed in FIGS. 5-9 on the active page 120.

In Steps 214, the method monitors for any pilot input affecting speed profile management, as well as, the reporting of the speed profile on the displays. If no pilot input is detected, the method proceeds to step 216 where it transmits the speed profile information to interfacing systems shown in FIG. 1 such as the Aircraft Control System 20 and the Flight Management System (FMS) 14 to control the speed profile of the airplane 42. The method then loops back to Step 210 and continues to calculate, process, and display the most current speed profile information for the active page 120.

In Step 214, if the method receives pilot input related to speed profile management and/or the reporting of the speed profile on the displays, the method processes the pilot input and loops back to Step 210 to calculate an updated speed profile. The updated speed profile is then displayed and transmitted per Steps 212-216.

It is important to note that aspects of the method can be made to be context-sensitive. For example, the speed profile can be displayed in pop-up or automatic mode whenever the airplane is transitioning from one phase of flight to another. By the way of example, and not limitation, the Descent page 112 may automatically be displayed when the aircraft begins its descent so that pilots can familiarize themselves with the speed profile of the descent. Another example is speed profile pop-up when a configuration-based speed restriction such as engine out or flap asymmetry becomes operative. Yet another example of context-sensitivity is the display of the speed profile whenever the airplane begins to execute a flight procedure such as noise abatement or Continuous Descent Approach (CDA). The updated speed profile can be displayed so that pilots can gain better situational awareness.

The method can also be used in a preview planning mode. In the preview planning mode, a subset of the steps, such as Step 202-212, can be utilized whereas in the active mode all steps, Steps 202-216, may be utilized. By the way of example and not limitation, the Descent page 112 may also be displayed when the airplane is in a climb or cruise phase of flight. In this case, a preview of the Descent page 112 would not utilize inputs from the MCP 94 or the Surveillance System 26, but may utilize the flight plan information and other FMS data of Step 204 for calculating the predicted speed profile in Step 210.

The subject matter described above is provided by the way of illustration only and should not be construed as limiting. While preferred embodiments have been described above and depicted in the drawings, other depictions of data tags and graphics symbology can be utilized in various embodiments of the disclosure. Graphical symbology may be used in place of text-based indications. Measurement units such as feet, meters, or miles may be suitably changed as appropriate for the task, custom, or convention. Lastly, the nomenclature, color, and geometric shape of the display elements can be varied without departing from the scope of the disclosure as defined by the appended claims.

We claim:

1. An airplane system for managing a speed profile of an airplane, comprising:
a computer having instructions having contents that perform a method that includes:
displaying at a first display location, a first information identifying a phase of flight of the airplane, the first information comprising at least one of a takeoff phase of flight, a climb phase of flight, a cruise phase of flight, a descent phase of flight, an approach phase of flight, and a landing phase of flight;
displaying at a second display location, a second information graphically depicting the speed profile of the airplane, the second information comprising at least one of a phase of flight indicator, a speed segment indicator, a speed command change indicator, an altitude indicator, a configuration indicator, a waypoint, a speed constraint, and a speed restriction;
displaying at a third display location, a third information identifying a flight procedure influencing the speed profile of the airplane for a phase of flight; and
displaying at a fourth display location, a fourth information including an interactive input tool controlling the speed constraints and the speed restrictions displayed at the second display location; and
a display operatively coupled to the computer to display the first, second, third and fourth information at the first, second, third, and fourth display location, respectively.

2. An airplane comprising:
a speed profile management system, the speed profile management system providing a speed profile of an airplane for a phase of flight;
a flight management system operatively connected to the speed profile management system;
a cockpit graphics display system operatively connected to the speed profile management system;
an aircraft control system operatively connected to the speed profile management system;
a navigation system operatively connected to the speed profile management system;
a control input device operatively connected to the speed profile management system; and
a graphical display of the speed profile of the airplane displayed on the cockpit graphical display system, wherein the speed profile is interactively managed on the graphical display to affect the speed of the airplane.

3. The airplane of claim 2 further comprising a communication system operatively connected to the speed profile management system.

4. The airplane of claim 2 further comprising a surveillance system operatively connected to the speed profile management system.

5. The airplane of claim 2 wherein the speed profile further comprises a phase of flight indicator, a speed segment indicator, a speed command change indicator, an altitude indicator, a configuration indicator, a waypoint, a speed constraint, and a speed restriction.

6. The airplane of claim 2 wherein the speed profile is controlled by a section of a flight procedure.

7. The airplane of claim 2 wherein the speed profile is interactively managed by speed profile control input tool, further wherein the speed profile control input tool configures at least one of economic speed, pilot-selected speed, altitude-based speed restriction, and waypoint speed constraint.

8. The airplane of claim 2 wherein the cockpit graphical display system comprises at least one of a Primary Flight Display (PFD), a Head-up Display (HUD), a Navigation Display (ND), an Electronic Flight Bag (EFB) display, a Multi-Function Display (MFD), and Speed Profile Management System (SPMS) display.

9. The airplane of claim 2 wherein the control input device is at least one of a control panel, a keyboard, a cursor with a cursor control device, line select keys (LSK) on a control display unit, and a touchscreen, further wherein the control input device may be integrated into at least one of a Mode Control Panel (MCP), a control display unit (CDU), an Electronic Flight Bag, and Speed Profile Management System (SPMS) control panel.

10. The airplane of claim 2 wherein the speed profile of a phase of flight comprises at least one of at least one of a takeoff phase of flight, a climb phase of flight, a cruise phase of flight, a descent phase of flight, an approach phase of flight, and a landing phase of flight.

11. The airplane of claim 2 further comprising an Electronic Flight Bag (EFB) system.

12. A computer-implemented method of managing a speed of an airplane, comprising:
initiating the Speed Profile Management System;
receiving a first information, the first information comprises of a flight plan information defining a lateral and a vertical flight profile of the airplane wherein the flight profile of the airplane are further defined by an originating airport, a destination airport, and intermediate waypoints;
receiving a second information, the second information comprising of information from an off-board source, wherein the information containing instructions affecting the speed of the airplane for at least a portion of the flight;
receiving a third information, the third information comprising of an airplane state and an airplane intent information from an on-board source, wherein the airplane state and airplane intent information affecting the speed of the airplane for at least a portion of the flight;
responsive to pilot input, calculating the speed profile of the airplane based on the first, second, and third information;
displaying the speed profile on an integrated and interactive graphical display;
updating continuously the calculated speed profile and the speed profile graphical display; and
transmitting the calculated speed profile to the Aircraft Control System to affect the speed of the airplane.

13. The computer-implemented method of claim 12 wherein the flight plan information further comprises of a phase of flight information, wherein the phase of flight information comprises of at least one of a takeoff phase of flight, a climb phase of flight, a cruise phase of flight, a descent phase of flight, an approach phase of flight, and a landing phase of flight.

14. The computer-implemented method of claim 12 wherein the off-board source comprises at least one of an air traffic control authority, an airline authority, and a second airplane with which the airplane is coordinating a flight procedure.

15. The computer-implemented method of claim 12 wherein the on-board source comprises at least of a Cockpit Graphical Display System (CGDS), a Navigation System, and an Aircraft Control System, the Aircraft Control System further comprising at least one of an autopilot system, an autothrottle system, and a Mode Control Panel (MCP).

16. The computer-implemented method of claim 12 wherein the aircraft state information comprises of information controlling the speed of the aircraft at a first time and intent information comprises of target information controlling the speed of the aircraft at a second time, the second time being different from the first time.

17. The computer-implemented method of claim 12 wherein calculating the speed profile of the airplane comprises of processing received information to calculate speeds for different phases of flight and segments, adjusting the speed profile based on flight procedures, speed constraints, and speed restrictions, transforming the speed profile calculations for applicable display management, and arranging speed profile information by phase of flight, significant altitudes, waypoints, speed segments, and speed restrictions for interactive management by a pilot.

18. The computer-implemented method of claim 12 wherein displaying the speed profile further comprises displaying the speed profile for at least one phase of flight on a cockpit display, further wherein the cockpit display is at least one of a Primary Flight Display (PFD), a Head-up Display (HUD), a Navigation Display (ND), an Electronic Flight Bag (EFB) display, a Multi-Function Display (MFD), and Speed Profile Management System (SPMS) display.

19. The computer-implemented method of claim 12 wherein initiating the SPMS comprises at least on of initiating the SPMS via a control input device and initiating the SPMS via a Flight Management System.

20. The computer-implemented method of claim 12 wherein transmitting the speed profile to the Aircraft Control System to affect the speed of the airplane, further comprises of commanding the Aircraft Control System to change the speed of the airplane to match the calculated speed profile of the SPMS.

21. A method of operating an airplane, the airplane having a real time graphical display, the display instantaneously displaying images reflecting commanded changes to the operating flight profile, the method comprising:
collecting airplane flight operating parameters in real time to create a real time airplane flight operating parameters information;
supplying the real time airplane flight operating parameter information to a cockpit graphical display and a speed profile management system;
displaying airplane flight operating parameters in real time on the cockpit graphical display;
processing an airplane speed profile command in the speed profile management system;
generating a speed profile of the command prior to the airplane operation reflecting such speed;
supplying commanded speed profile information to the cockpit graphical display from the speed profile management system; and
displaying instantaneously graphical images reflecting the airplane speed profile prior to the airplane operation reflecting such change.

22. The method of claim 21 further comprising validating the airplane speed profile command in the speed profile management system.

23. The method of claim 21 further comprising enabling a pilot viewing of the graphical display of the commanded speed profile change to validate the commanded speed profile change.

24. The method of claim 21 further comprising enabling a pilot viewing the graphical display of the commanded speed profile change to change the commanded speed profile.

25. The method of claim 21 further comprising:
collecting airplane operating speed profile information in the speed profile management system;
supplying the airplane operating speed profile information to the graphical display from the speed profile management system;
displaying the actual speed profile of the airplane in the graphical display.

26. The method of claim 21 further comprising validating the speed profile by comparing the displayed actual performance with the projected performance after the change.

27. The method of claim 21 further comprising changing the speed profile by comparing the displayed actual performance with the projected performance after the change.
